(19) United States
(12) Patent Application Publication
(10) Pub. No.: US 2026/0172149 A1
(43) Pub. Date: Jun. 18, 2026

(54) SYSTEMS AND METHODS FOR CHANNEL COVERAGE ENHANCEMENT

(71) Applicant: ZTE CORPORATION, Shenzhen (CN)

(72) Inventors: Junli LI, Shenzhen (CN); Nan ZHANG, Shenzhen (CN); Fangyu CUI, Shenzhen (CN); Yachao YIN, Shenzhen (CN)

(73) Assignee: ZTE CORPORATION, Shenzhen (CN)

(21) Appl. No.: 19/534,498

(22) Filed: Feb. 9, 2026

Related U.S. Application Data
(63) Continuation of application No. PCT/CN2023/112366, filed on Aug. 10, 2023.

(51) Int. Cl. H04L 1/1812; H04W 72/231; H04W 76/20

(52) U.S. Cl. CPC H04L 1/1812; H04W 72/231; H04W 76/20

(57) ABSTRACT

Presented are systems and methods for channel coverage enhancement. A wireless communication device (e.g., UE) may can receive a message to detection from a wireless communication node (e.g., base station (BS)). The wireless communication device can determine whether a quality of a wireless channel is poor according to the detecting of the message.

### CROSS-REFERENCE TO RELATED APPLICATION

This application claims the benefit of priority under 35 U.S.C. § 120 as a continuation of PCT Patent Application No. PCT/CN2023/112366, filed on Aug. 10, 2023, the disclosure of which is incorporated herein by reference in its entirety.

### TECHNICAL FIELD

The disclosure relates generally to wireless communications, including but not limited to systems and methods for channel coverage enhancement.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) can receive/obtain/acquire/get a message to detection from a wireless communication node (e.g., base station (BS), gNB, or transmission and reception point (TRP)). The wireless communication device can determine whether a quality of a wireless channel is poor according to the detecting of the message.

In some implementations, the message can comprise a defined signal or channel transmission, the message comprising at least one of: a paging message; a wake-up signal (WUS) or group WUS (GWUS) for paging; a paging early indication (PEI) for paging; a downlink control information signaling or a transmission of a physical downlink control channel (PDCCH); a demodulation reference signal (DMRS); a channel state information reference signal (CSI-RS) based reference signal (RS); a tracking reference signal (TRS); a secondary synchronization signal (SSS) based signal; a RS in combination with a synchronization signal block (SSB); a RS with a specific sequence; and/or a message based on a defined sequence.

In some implementations, the defined sequence can comprise or can be based on at least one of: a pseudo-random sequence, a Gold sequence, a low peak-to-average power ratio (PAPR) sequence, defined by a cyclic shift of a base sequence, a Zadoff-Chu (ZC) sequence, an m sequence, a Hadamard sequence, a cyclic shift of a ZC sequence, an orthogonal sequence, a UE group specific sequence, a UE specific sequence, a sequence assigned or determined based on a UE specific basis, a RS sequence with defined pattern, a defined RS sequence, at least one of a sequence or pattern of a defined reference signal, and/or a sequence based at least on WUS design.

In some implementations, the message may be specific to: the wireless communication device, a group of wireless communication devices, or a cell. In some implementations, the message may be transmitted/sent/provided/communicated by the wireless communication node, following a paging message transmitted at one or more paging occasions of the wireless communication device, for the wireless communication device that has entered RRC_CONNECTED, RRC_INACTIVE, or RRC_IDLE state.

In some implementations, the message may be transmitted by the wireless communication node, following a paging message with paging information initiated by core network (CN) and/or radio access network (RAN), transmitted at one or more paging occasion of the wireless communication device, for the wireless communication device that has entered RRC_INACTIVE, or RRC_IDLE state. In some implementations, wherein: the message may be transmitted by the wireless communication node, following a wake-up signal (WUS) or group WUS (GWUS) transmitted in a WUS transmission opportunity for incoming paging information, for the wireless communication device that has entered RRC_IDLE state; the RRC_IDLE state of the wireless communication device may be in response to at least one of: reception of an RRCEarlyDataComplete indication, reception of an RRCConnectionRelease indication not including an noLastCellUpdate indication, and/or reception of the RRCConnectionRelease indication including the noLastCellUpdate indication, wherein a start of the WUS transmission opportunity may be determined by a time offset according to a gap between an end of a prior WUS or GWUS and an associated paging occasion.

In some implementations, wherein: the message may be transmitted by the wireless communication node, following a paging early indication (PEI) transmitted at a PEI occasion for incoming paging information, for the wireless communication device that has entered RRC_IDLE or RRC_INACTIVE state; the PEI occasion can comprise a set of PDCCH monitoring occasions (MOs); the PEI occasion can include one or more time slots specified by an nrofPDCCH-MonitoringOccasionPerSSB-InPO indication; a time location of the PEI occasion may be determined by a reference point and an offset: the reference point may be at a start of a reference frame determined by a frame-level offset; and/or the offset is a symbol-level offset from the reference point to a start of a first physical downlink control channel (PDCCH) MO of the PEI occasion.

In some implementations, wherein at least one of: the message can be transmitted by the wireless communication node at a resource configured via higher layer signaling by the wireless communication node; and/or the resource can comprise at least one of: a time domain resource to send the message, a frequency domain resource to send the message, and/or a radio network temporary identifier (RNTI) that is specific to a group of wireless communication devices, specific to the wireless communication device, and/or specific to a cell of the wireless communication device, to scramble or initialize the message. The higher layer signaling may comprise at least one of: radio resource control (RRC) signaling, medium access control (MAC) signaling, system information block (SIB) signaling, and/or other signalings.

In some implementations, the wireless communication device can determine that the quality of the wireless channel is poor, when at least one of following conditions is satisfied: the detecting or decoding of the message has failed; number of attempts at detecting or decoding the message has reached a first configured maximum number of times and have failed; a detected strength of the message is lower than a first configured threshold; a detection window of the message that includes a plurality of detection periods has expired; detection or decoding of an associated paging channel has failed; number of attempts at detecting the associated paging channel has reached a second configured maximum number of times and have failed; a detected strength of paging is lower than a second configured threshold; detection or decoding of a wake-up signal (WUS) or group WUS (GWUS) has failed; number of attempts at detecting or decoding the WUS or GWUS has reached a third configured maximum number of times and have failed; a detected strength of the WUS or GWUS is lower than a third configured threshold; detection or decoding of a paging early indication (PEI) signal has failed; number of attempts at detecting or decoding the PEI has reached a fourth configured maximum number of times and have failed; a detected strength of the PEI signal is lower than a fourth configured threshold; and/or all candidate cells are not detected. At least one of the first, second, third, or fourth configured maximum number of times, the first, second, third, or fourth configured threshold, and/or the detection window may be configured by a higher layer signaling. The higher layer signaling can comprise at least one of: a radio resource control (RRC) signaling, a medium access control (MAC) signaling, a system information block (SIB) signaling, and/or other signalings.

In some implementations, the wireless communication device may send/provide/transmit a first indication to a higher layer to indicate that a channel condition is poor. The higher layer can comprise at least one of: a medium access control (MAC) layer, a radio resource control (RRC) layer, an application layer, and/or a layer higher than a physical layer. The first indication can comprise at least one of: a measured signal strength, an indicator of signal strength, an indicator that a signal is poor, and/or information including a recommended position.

In some implementations, the information including the recommended position can comprise: an indication of at least one valid and/or available geographical area. In some implementations, the indication can comprise an indication of at least one of: a plurality of concentric circular areas, with corresponding levels of channel or coverage performance that vary monotonically across the plurality of concentric circular areas; a plurality of radii of the plurality of concentric circular areas; at least one coordinate, each corresponding to a reference point or center point of one or more of the plurality of concentric circular areas; and/or a first radius and at least one offset value relative to the first radius, each of the at least one offset value corresponding to a respective one of the plurality of concentric circular areas.

In some implementations, the indication can comprise an indication of at least one of: one or more non-concentric circular areas; a plurality of coordinates, each corresponding to a reference point or center point of a respective one of the one or more non-concentric circular areas; and/or at least one radius each corresponding to at least one of the one or more non-concentric circular areas, or each corresponding to at least one of the plurality of coordinates. In some implementations, the indication can comprise an indication of at least one of: a plurality of coordinates to define a boundary or coverage of a respective one of the at least one valid or available geographical area.

At least one aspect is directed to a system, method, apparatus, or a computer-readable medium of the following. A wireless communication node can send a message to a wireless communication device for detection. The wireless communication device can determine, according to the detection, whether a quality of a wireless channel is poor.

The systems and methods presented herein include a novel approach for channel coverage enhancement. Specifically, the systems and methods presented herein discuss a novel solution for determining one or more signaling that may be utilized/used for the UE to detect and/or initiate/make a decision (e.g., response) on channel quality. The signaling can be referred to as or correspond to an alert message (e.g., the message used to be detected/measured by the UE), message to detection, detection message, or detection measurement message, which may be used interchangeably, for example. The systems and methods can determine when to send the alert message, operations for the UE to determine that it is in a weak coverage based on the receiving of the alert message, the action for the UE to execute/perform after determining that it is in a relatively weak coverage and/or behavior (e.g., indication or indicator) to end user, the configuration method of the recommended position, and/or techniques to configure downlink control information (DCI)-based overridden or direct indication, among other novel solutions discussed herein.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example overview of UE state transitions, in accordance with some embodiments of the present disclosure;

FIG. 5 illustrates an example schematic diagram of paging early indication (PEI) for paging, in accordance with some embodiments of the present disclosure;

FIG. 6 illustrates an example circular geographical area of non-terrestrial network (NTN) areas, in accordance with some embodiments of the present disclosure;

FIG. 7 illustrates an example polygon geographical area of NTN areas, in accordance with some embodiments of the present disclosure; and

FIG. 8 illustrates a flow diagram of an example method for channel coverage enhancement, in accordance with an embodiment of the present disclosure.

### DETAILED DESCRIPTION

### 1. Mobile Communication Technology and Environment

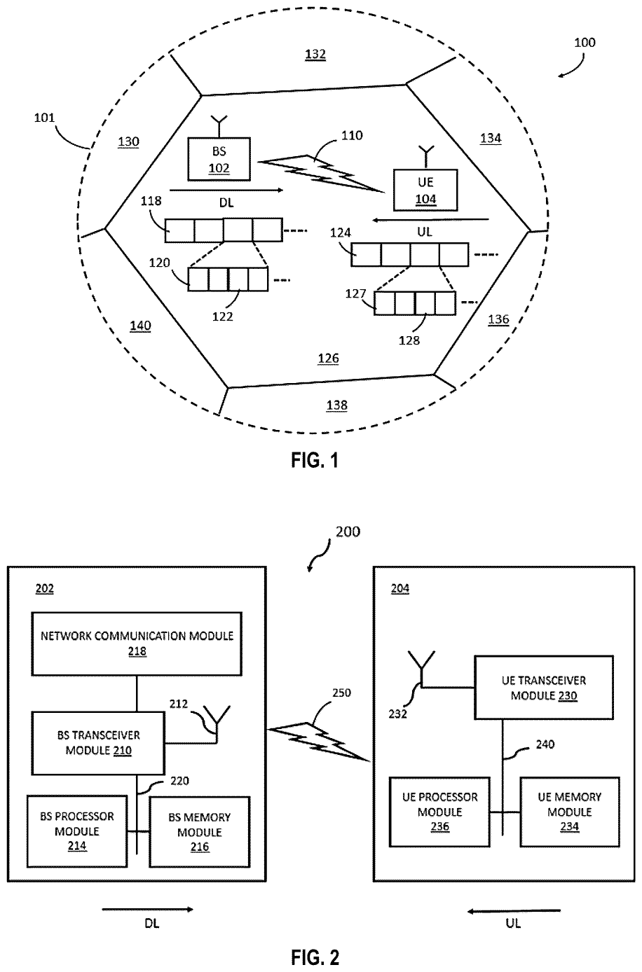

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Channel Coverage Enhancement

In certain communication systems, sole terrestrial networks may not provide a complete/thorough communication service for all use cases (e.g., may not provide coverage for certain areas), such as geographically remote areas where terrestrial networks may not be used/utilized, and/or for certain emergency networks (e.g., islands, ships, forests, etc.). In such cases, non-terrestrial networks (NTNs) can be supported or provided for network communication. For example, satellites in the NTN can be leveraged in the field of information and communication for its wide coverage, minimal terrain impacts or obstructions, and/or independent of terrestrial network devices, stations, or components (e.g., fixed ground BS). By using NTN for communication to/with various terrestrial devices, terminals (e.g., satellite, UE 104, BS 102, etc.) may provide network connectivity at various locations for global coverage, such as for the respective mobile services.

However, in network deployment, it may be difficult/challenging to provide complete/fully seamless coverage, for instance, due to the distance between satellites (or NTN components/devices) and the UEs 104 (e.g., terrestrial devices). For example, the signals from the satellites may be blocked/obstructed/interfered with/by the atmosphere (e.g., clouds, etc.) or other objects/structures (e.g., being a pocket or a bag) between the UEs 104 and the satellites, thereby resulting in relatively poor and/or, in some cases, disconnected communication signals. In such cases, certain UEs 104 may experience relatively poor downlink reception within NTN coverage, where the receiver signal-to-noise ratio (SNR) may be below a desired SNR, such as below 18 dB, etc. These UEs 104 may miss or may not receive timely downlink paging calls and/or paging short messages due to the poor receiver SNR, for instance, including scenarios with an extended channel with relatively larger repetition.

For example, for a downlink (DL) dominated behavior scenario (e.g., the majority of the communication resources, such as time, frequency, and/or power, are allocated for the downlink transmission from the BS 102 (or network) to the UE 104 (or receiver)), the paging calls and paging short messages may include or correspond to user terminated calls. The received calls/messages may experience relatively lower SNR without cooperative behavior from the end user side (e.g., the operator of the UE 104). Because these paging calls and/or paging messages, such as those for public safety purposes, may be important to various users or operators of the UEs 104, it may be desired (or crucial) to introduce or implement a dedicated paging alert channel (or signal) to allow/enable the delivery of an emergency paging and/or allow transitioning from insufficient link budget scenario (e.g., a scenario with relatively poor coverage) to sufficient link budget scenario (e.g., a scenario with relatively good coverage). In such cases, the UE 104 can be informed/notified via potential pop-up information, e.g., for the UE 104 to move/relocate to a relatively better signal reception location for communication and/or send a reminder to the UE 104 on the potential upcoming DL traffic, such as to indicate for the user to move the UE 104 from any potential obstruction (e.g., remove the UE 104 from pocket or bag of the user).

Therefore, the systems and methods of the technical solution can provide techniques for determining what signalings can be used for the UE 104 to detect and make a decision on channel quality. The signaling can be provided as an alert message. The systems and methods of the technical solution can determine when to send the alert message, provide operations for the UE 104 to determine whether it is in a relatively weak coverage based on the receiving of the alert message, indicate/provide or determine the action for the UE 104 to take after determining that it is in a relatively weak coverage, and/or determine or provide at least one device behavior or response to the user (e.g., an indication to the user) based on the coverage quality. In some cases, the systems and methods of the technical solution can provide a recommended position for the UE 104.

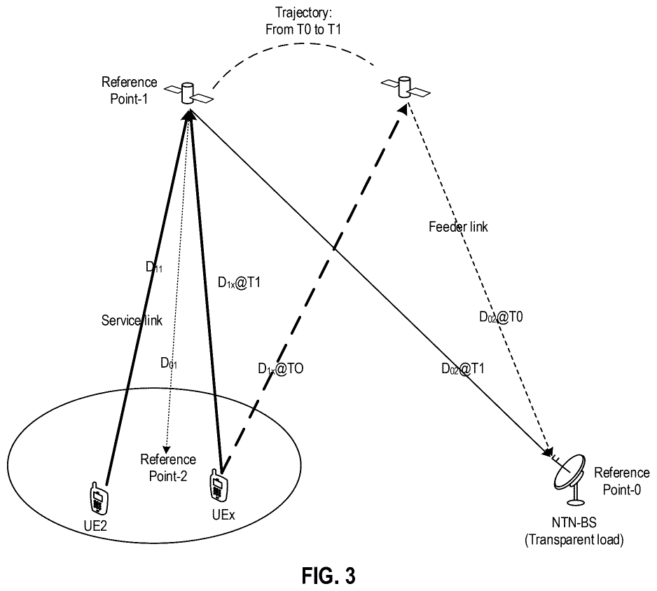

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell.

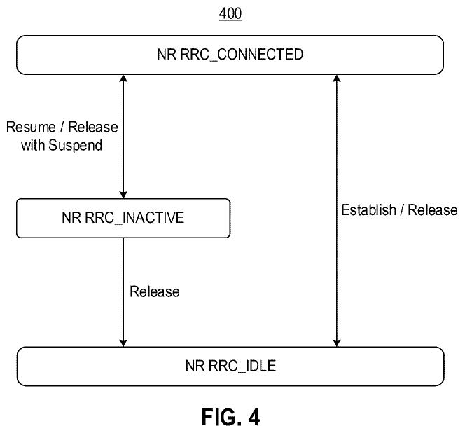

In certain networks, the UE 104 can be in an RRC_CONNECTED state or an RRC_INACTIVE state when an RRC connection is established. In some cases, if the RRC connection is not established, the UE 104 can be in the RRC_IDLE state. Referring to FIG. 4, depicted is an example overview 400 of UE state transitions, in accordance with some embodiments of the present disclosure. As shown, the example overview 400 can provide UE RRC state machine and state transitions in the communication network. The UE 104 can include or be in one RRC state/mode in the certain communication network at a time, such as RRC_CONNECTED state, RRC_INACTIVE state, or RRC_IDLE state. The RRC_INACTIVE state can be used to reduce terminal energy consumption and time delay, for example.

In various configurations, a wake-up signal (WUS) can include or correspond to a power-saving signal that the UE 104 may monitor before or prior to monitoring paging when the UE 104 is in an idle state. For example, when discontinuous reception (DRX) (e.g., DRX mode) is used and the UE 104 detects WUS, the UE 104 can monitor the following paging occasion (PO). When an extended DRX is used and the UE 104 detects WUS, the UE 104 can monitor the following number of POs (numPOs) or until a paging message including the UE's network access security (NAS) identity is received/obtained/acquired, whichever is earlier. If the UE 104 does not detect WUS, in some cases, the UE 104 may monitor (e.g., not required to monitor) one or more following PO(s). If the UE 104 missed a WUS occasion (e.g., due to cell reselection), the UE 104 may monitor every POs until the start of the next WUS or until the paging time window (PTW) ends, whichever is earlier.

In various cases, the purpose of paging may be similar or different for different wireless communication technologies. For example, in certain wireless communication technologies, paging can be utilized to perform at least one of, but not limited to, the following functions:
1) Triggering radio resource control (RRC) setup;
2) System information modification;
3) Indication (e.g., providing an indication) of public warning system (PWS), earthquake and tsunami warning system (ETWS), and/or commercial mobile alert system (CMAS) notification, among other types of notifications;
4) Notification of emergency access barring (EAB) and/or uplink access class (UAC) parameters change, etc.; and/or
5) Inter-frequency redistribution procedure.

In certain systems, paging functions may be for triggering RRC setup (e.g., RRC request and/or RRC connection resumption). System information modification and PWS/ETWS notification may be performed by DCI 1_0 with P_RNTI and corresponding physical downlink shared channel (PDSCH), for example. The BS 102 (or network) may initiate/start the paging procedure/operation/method by transmitting/sending the paging message at the UE's paging occasion as specified or provided in the specification.

In some configurations, to reduce the power consumption of IDLE or INACTIVE UE monitoring physical downlink control channel (PDCCH), certain systems provide or implement a paging early indication (PEI) scheme. The PEI scheme can include inserting a PEI occasion (PEI-O) before the paging occasion (PO), and the UE 104 can determine whether to demodulate the PO information after demodulating the PEI information. Among the PEI-Os, the BS 102 can inform the UE 104 of PEI-O via RRC messages, or types of signaling messages.

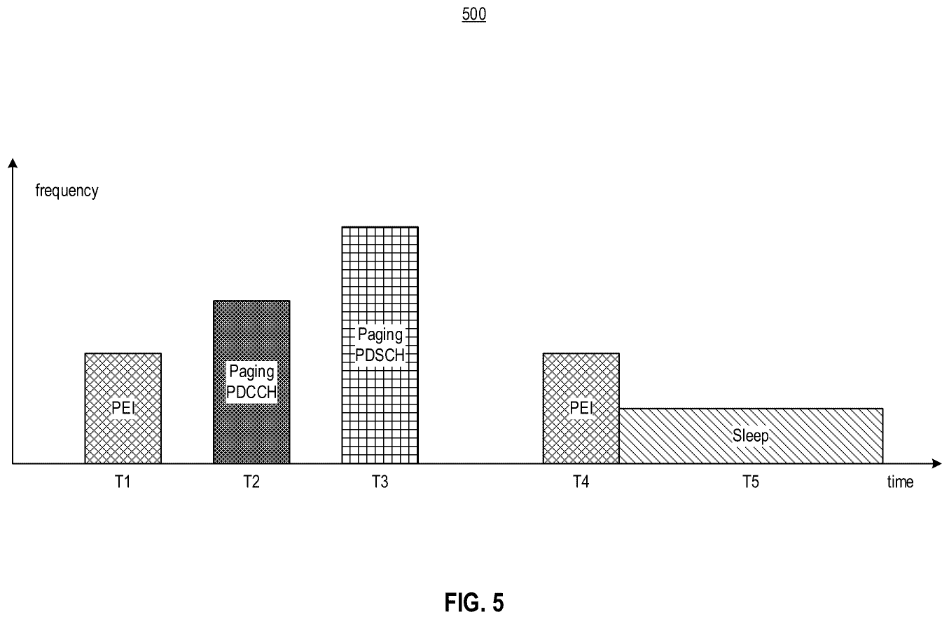

FIG. 5 illustrates an example schematic diagram 500 of PEI for paging, in accordance with some embodiments of the present disclosure. As shown, at T1, the UE 104 may be demodulated to PEI, which can include at least one subgroup identifier (ID) of the UE 104. At T2, the UE 104 may be configured to demodulate PO's PDCCH. If the UE 104 demodulates to paging itself, PDSCH related to paging may continue to be demodulated at T3. At T4 of the next paging cycle, the UE 104 can demodulate a PEI message that does not include the UE's own subgroup ID. At T5, the UE 104 may not be required to continue or may avoid demodulating PO. In such cases, the UE 104 can enter a sleep state to conserve/save power, for example.

In certain systems, DCI 2_7 (e.g., format 2_7, or other signalings) can be used to notify one or more UEs 104 of power-saving information before paging occasion, for example. In this case, this DCI can include PEI-radio network temporary identifier (RNTI) scrambling and include, for example:
Paging indication field

$$- {N}_{P O}^{PEI} {N}_{S G}^{P O} bit ( s ) ,$$

where

$${N}_{P O}^{PEI}$$

can be the number of paging occasions configured by higher layer parameter po-NumPerPEI;

$${N}_{S G}^{P O}$$

can be the number of sub-groups of a paging occasion configured by higher layer parameter subgroupsNumPerPO;
Each bit in the field may indicate one UE subgroup of a paging occasion.
TRS availability indication—1, 2, 3, 4, 5, or 6 bits, where the number of bits can equal to one plus the highest value of all the indBitID(s) provided by the trs-ResourceSetConfig if configured; 0 bits otherwise.

The size of DCI format 2_7 may be indicated by the higher layer parameter payloadSizeDCI-2-7, according to the specification. The number of information bits in format 2_7 can be equal to or less than the payload size of format 2_7. If the number of information bits in format 2_7 is less than the size of format 2_7, the remaining bits are reserved.

In certain implementations, regarding the enhancement of the poor coverage, an indication can be provided from the UE 104 to a higher layer to indicate that a channel condition may be poor. The higher layer can determine whether to activate a popup indication to the user of the UE 104 by decoding the content of the indication from the UE 104. The popup indication can include an indicator of whether to move, an indicator indicating cellular coverage performance, an indicator of whether there is cellular coverage, and/or information including the recommended position, which can alert the UE 104 (or the user) to move to a relatively better signal reception location for communication. In such implementations, the aspects of what signal/channel the UE 104 can detect to determine whether the coverage is good, how the condition of the UE 104 can be used to determine to send the alert message to its higher layer, how the UE 104 can send the indication to its higher layer, and/or how the higher layer determines whether the coverage is good and inform the user to move a relatively better coverage area can be provided or configured.

To introduce a dedicated paging alert channel to allow/enable the delivery of an emergency paging and allow transitioning from an insufficient link budget scenario to a sufficient link budget scenario, the following can be provided or defined:
1) Alert message related:
   a. What signaling can be used for the UE 104 to detect and make a decision on channel quality (e.g., the signaling can correspond to or be an alert message);
   b. When to send the alert message;
   c. How the UE 104 determines whether it is in a relatively weak coverage (or channel) based on or according to receiving the alert message; and/or
2) Action to take after determining that the UE 104 is in a relatively weak coverage and the UE's behavior (e.g., response) to the user according to the coverage quality.

In some arrangements, the alert message (e.g., a message to detection) may refer to a signal that is used for UE detection to decide on or determine the channel quality. In some cases, the alert message may not indicate an alert from the BS 102 (or network) to the UE 104. The UE 104 can determine whether the channel is poor (e.g., weak coverage) based on the detection results of the alert message. In some arrangements, the alert indication (e.g., first indication) may refer to an indicator that the UE 104 sent to its higher layer to inform the user that the channel is poor. The example implementations, such as example implementations 1, 2, and/or 3 can be used for the UE 104 in IDLE, INACTIVE, and/or CONNECTED state, among other states of the UE 104.

### Example Implementation 1: Alert Configuration for Coverage Enhancement of Poor Channel

In various configurations, for the alert message, the related information can include or be defined as follows.

### Signals of the Example Implementation 1 Used for UE to Detect and Make Decision on Channel Quality

In some implementations, regarding the alert message (e.g., sent by the BS 102 and detected by the UE 104), an existing signal or channels can be reused, such as for the alert message to include the existing signal or channel. In some other implementations, a dedicated message/signal can be defined for the alert message (e.g., the alert message can include a defined signal). For these types of signals (among others), the alert message can be used by the UE 104 to detect and/or determine whether the channel quality is relatively poor (or strong). At least one of the following example signalings can be detected:
1) Based on an existing channel/signal (e.g., channel transmission), such as:
   a. Channel/RS signals, such as at least one of:
      i. Paging message;
      ii. Wake-up signal (WUS) or group WUS (GWUS) for paging;
      iii. PEI for paging;
      iv. PDCCH channel (e.g., existing DCI format can be at least one of DCI format 0_0/1/2, DCI format 1_0/1/2, DCI format 2_0/1/2/3/4/5/6/7, and/or other formats);
      v. DMRS;
      vi. CSI-RS type RS or test reference signal (TRS); and/or
      vii. Secondary synchronization signal (SSS)-like.
2) A dedicated message based on or according to a new sequence, such as at least one of:
   a. Pseudo-random sequence which may be defined by a length-31 Gold sequence.
   b. Low-PAPR sequence which can be defined by a cyclic shift of a base sequence.
   c. ZC sequence.
   d. m sequence.
   e. Hadamard sequence.
   f. Cyclic shift of ZC sequence.
   g. Orthogonal sequence.
      i. UE group-specific sequence.
      ii. UE specific sequence.
   h. UE-specific basis sequence.
      i. using sequences derived from length 31 Gold sequences, and by using specific-RNTI or C-RNTI in the sequence initializer, sequences can be assigned on a UE-specific basis, and the UE 104 can use a sequence detector to identify whether the channel is poor, for example.
   i. Gold sequence.
   j. New RS sequence and/or pattern.
   k. Existing RS with a new pattern.
   l. RS in combination with SSB.
   m. A sequence based on the WUS design.

At least one of the aforementioned alert messages can be UE group-specific (e.g., specific to the UE group), UE-specific (e.g., specific to the UE 104), or cell-specific (e.g., specific to the cell), which may depend on the RNTI type used to scramble cyclic redundancy check (CRC) or sequence or initialize in the sequence initializer.

### Example Time or Occasion to Send an Alert Message of the Example Implementation 1

In various configurations, for the dedicated message of the alert message, the time or occasion (e.g., when) to send alert messages can be considered, such as to address a new dedicated alert message. In some cases, one or more of the following example conditions can be considered:
1) When the BS 102 (e.g., network, gNB, wireless communication node, or TRP) transmits/sends/provides paging information (e.g., paging message with paging information) at the UE's paging occasion (e.g., the PO can be specified in the specification) to the UE 104 in or has entered RRC_CONNECTED, RRC_INACTIVE, and/or RRC_IDLE state for triggering one or more operations (e.g., RRC setup, system information changes, indication of PWS/ETWS/CMAS notification, notification of EAB/UAC parameters change, inter-frequency redistribution procedure, etc.), the BS 102 can send an alert message to the UE 104. For example, the BS 102 can send the alert message (e.g., message to detection or detection message) to the UE 104 following the paging message transmitted at one or more paging occasions of the UE 104, such as for the UE 104 that entered RRC_CONNECTED, RRC_INACTIVE, and/or RRC_IDLE state.
   The number/or and the start of the paging occasions can be specified in the specification (e.g., the number can be determined by Ns which is signaled in SIB1, among other signalings).
2) When or following the BS 102 sends/transmits a paging message with paging information initiated by core network (CN) and/or RAN in the UE's paging occasion to the UE 104 in RRC_INACTIVE or RRC_IDLE state, the BS 102 can send an alert message to the UE 104.
   The number of paging occasions can be indicated/specified in the specification (e.g., determined by Ns which can be signaled in SIB1).
3) The BS 102 can send an alert message to the UE 104 of the cell, when or following the BS 102 transmits a WUS or GWUS in a WUS transmission opportunity for incoming paging information, such as to a cell in which the UE 104 most recently entered RRC_IDLE state. The RRC_IDLE state of the UE 104 can be in response to or triggered by at least one of:
   Reception of RRCEarlyDataComplete,
   Reception of RRCConnectionRelease not including noLastCellUpdate, and/or
   Reception of RRCConnectionRelease including noLastCellUpdate and the UE 104 was using WUS or GWUS in the cell prior to this RRC connection attempt; and/or
   The time offset of the WUS transmission opportunity determined by or according to a gap between the end of a prior WUS or GWUS and an associated PO can be used to determine or calculate the start of the WUS transmission opportunity.
4) The BS 102 can send an alert message to the UE 104 when or following the BS 102 sends/transmits a paging early indication (PEI) at a PEI occasion for incoming paging information to the UE 104 in RRC_IDLE and/or RRC_INACTIVE state.
   PEI occasion can be a set of PDCCH monitoring occasions (MOs), including, or in some cases consisting, of multiple time slots (e.g., subframes or OFDM symbols, etc.) provided or specified by nrofPDCCH-MonitoringOccasionPerSSB-InPO where the PEI can be sent.
   The time location of PEI-O for UE's PO may be determined by a reference point and/or an offset:
      The reference point can be the start of a reference frame determined by a frame-level offset from the start of the first PF of the PF(s) associated with the PEI-O, provided by pei-Frame Offset in SIB1;
      The offset can be a symbol-level offset from the reference point to the start of the first PDCCH MO of this PEI-O, such as provided by firstPDCCH-MonitoringOccasionOfPEI-O in SIB1.
      nrofPDCCH-MonitoringOccasionPerSSB-InPO can indicate a number of PDCCH monitoring occasions corresponding to an SSB within at least one PO. The value can be 2, 3, or 4, among others.
5) The BS 102 can send an alert message at a resource configured by the BS 102 to the UE 104. The resource information to send the alert message can be configured by or via higher layer signaling. The higher layer signaling can include but is not limited to, at least one of: radio resource control (RRC) signaling, medium access control (MAC) signaling, and/or system information block (SIB) signaling. The resource can include, but is not limited to, the following example:
   a. The time domain resource to send the alert message;
   b. The frequency domain resource to send the alert message, and/or
   c. RNTI which can be UE group-specific, UE-specific, or cell-specific to scramble or initialize the message (e.g., the alert message).
      Example Operations of the Example Implementation 1 for UE Determination of Whether it is in a Weak Coverage Region based on the Received Alert Message

In various implementations, according to or based on the received alert message, the UE 104 can consider at least one of the following conditions, techniques, methods, implementations, or operations to determine whether it is in a weak coverage region/area/location/position:
1) Detection or decoding of the alert message (e.g., newly defined message, existing channel/signal, etc.) has failed;
2) Detection or decoding attempts of the alert message (e.g., newly defined message, existing channel/signal, etc.) have reached a configured or predetermined maximum times (e.g., a first, second, third, and/or fourth configured maximum number of times) and have failed (e.g., number of attempts at detecting or decoding the message has reached the first configured maximum number of times and have failed);
3) The detection strength of the alert message (e.g., newly defined message) is lower than a configured threshold (e.g., first, second, third, and/or fourth configured threshold);
4) A detection window (e.g., T1) of the alert message (e.g., newly defined message) that includes a plurality of detection periods (e.g., t1) has expired;
5) Detection or decoding of a paging channel has failed;
6) The detection or decoding attempts of a paging channel have reached a configured or predetermined maximum time (e.g., a second configured maximum number of times) and have failed;
7) Detection strength of paging is lower than a configured threshold (e.g., a second threshold);
8) Detection or decoding of a WUS and/or GWUS signal has failed;
9) The detection or decoding attempts of the WUS or GWUS signals have reached a configured or predetermined maximum time (e.g., a third configured maximum number of times) and have failed;
10) Detection strength of WUS or GWUS is less/lower than a configured threshold (e.g., a third configured threshold);
11) Detection or decoding of a PEI signal has failed;
12) Detection or decoding attempts of a PEI have reached a configured or predetermined maximum time (e.g., a fourth configured maximum number of times), and have failed;
13) Detection strength of PEI is lower than a configured threshold (e.g., a fourth configured threshold); and/or
14) All candidate cells are not detected.

Based on the potential methods discussed herein above, the following implementation examples may be considered.

Example 1: when the UE 104 monitors a paging message at paging occasion sent by the BS 102 (or the network), if the paging message cannot be detected or cannot be decoded correctly or the strength of the alert message detected by the UE 104 is lower than the configured threshold (e.g., the second configured threshold), the UE 104 can determine that it is in a weak coverage region.

Example 2: when the UE 104 monitors a paging message at paging occasion sent by the BS 102, if the paging message cannot be detected or cannot be decoded correctly for a predetermined or configured consecutive times (e.g., at least one of the configured number of attempts, the second configured maximum number of times), the UE 104 can determine that it is in a weak coverage region.

Example 3: when the UE 104 monitors a paging message at paging occasion sent by the BS 102, if the strength of paging message detected by UE 104 is lower than the configured threshold (e.g., the second configured threshold) for a configured number of consecutive times (e.g., the second configured maximum number of times), the UE 104 may determine that it is in a weak coverage region.

Example 4: when the UE 104 monitors a WUS or GWUS at WUS opportunity (e.g., WUS transmission opportunity) sent by the BS 102, if the WUS or GWUS cannot be detected or cannot be decoded correctly and/or the strength of the WUS or GWUS detected by UE 104 is lower than the configured threshold (e.g., the third configured threshold), the UE 104 may determine that it is in a weak coverage region.

Example 5: when the UE 104 monitors a WUS or GWUS at WUS opportunity sent by the BS 102, if the WUS or GWUS cannot be detected or cannot be decoded correctly for a configured consecutive times (e.g., the third configured maximum number of times, or a predetermined number of attempts), the UE 104 can determine that it is in a weak coverage region.

Example 6: when the UE 104 monitors a WUS or GWUS at WUS opportunity sent by the BS 102, if the strength of WUS or GWUS detected by UE 104 is lower than the configured threshold (e.g., the third configured threshold) for a configured number of consecutive times (e.g., the third configured maximum number of times), the UE 104 can determine that it is in a weak coverage region.

Example 7: when the UE 104 monitors a PEI at a PEI-O sent by the BS 102, if the PEI cannot be detected or cannot be decoded correctly and/or the strength of the PEI detected by the UE 104 is lower than the configured threshold (e.g., the fourth configured threshold), the UE 104 can determine that it is in a weak coverage region.

Example 8: when the UE 104 monitors a PEI at PEI-O sent by the BS 102, but cannot detect the PEI or it cannot be decoded correctly for a configured number of (e.g., consecutive) times (e.g., the fourth configured maximum number of times, or a predetermined number of attempts), the UE 104 may determine that it is in a weak coverage region.

Example 9: when the UE 104 monitors a PEI at PEI-O sent by the BS 102, if the strength of PEI detected by UE 104 is lower than the configured threshold (e.g., a fourth configured threshold) for a number of times (e.g., consecutive times, or the fourth configured maximum number of times), the UE 104 may determine that it is in a weak coverage region.

Example 10: when the UE 104 monitors the alert message sent by the BS 102, if the alert message cannot be detected or cannot be decoded correctly and/or the strength of the alert message detected by UE 104 is lower than the configured threshold, the UE 104 may determine that it is in a weak coverage region.

Example 11: when the UE 104 monitor the alert message sent by the BS 102, if the alert message cannot be detected or cannot be decoded correctly for a configured number of consecutive times, the UE 104 may determine that it is in a weak coverage region.

Example 12: when the UE 104 monitor the alert message sent by the BS 102, if the strength of alert message detected by UE 104 is lower than the configured threshold for a configured number of consecutive times, the UE 104 may determine that it is in a weak coverage region.

Example 13: when the UE 104 monitor the alert message sent by the BS 102, according to the detection time window T1 and the detection period t1, such as discussed herein, the UE 104 can start timing from the detection time window T1 initially, and attempt to detect the alert message at the interval period t1. When the time expires (e.g., timeout expiration), if the UE 104 does not detect the alert message sent by the BS 102, such as paging, WUS or GWUS, PEI, dedicated sequence, DMRS, etc., the UE 104 may determine that it is in a weak coverage region.

Example 14: after monitoring the paging information at PO, and/or WUS or GWUS at WUS opportunity, and/or PEI at PEI-O, if the paging information cannot be detected or is decoded incorrectly, and/or the detected strength is lower than configured threshold, the UE 104 can monitor the alert message sent by the BS 102. If the alert message cannot be detected or cannot be decoded correctly, and/or the strength of the alert message detected by UE 104 is lower than the configured threshold, the UE 104 may determine that it is in a weak coverage region.

Example 15: after monitoring the paging information at PO, WUS or GWUS at WUS opportunity, and/or PEI at PEI-O, if the paging information cannot be detected or is decoded incorrectly, and/or the detected strength is lower than the configured threshold, the UE 104 can monitor alert message sent by the BS 102. If the alert message cannot be detected or cannot be decoded correctly for a configured number of consecutive times, the UE 104 may determine that it is in a weak coverage region.

Example 16: after monitoring the paging information at PO, WUS or GWUS at WUS opportunity, and/or PEI at PEI-O, if the paging information cannot be detected or is decoded incorrectly, and/or the detected strength is lower than the configured threshold, the UE 104 can monitor alert message sent by the BS 102. If the strength of alert message detected by UE 104 is lower than the configured threshold for a configured number of consecutive times, the UE 104 may determine that it is in a weak coverage region.

Example 17: after monitoring the paging information at PO, WUS or GWUS at WUS opportunity, and/or PEI at PEI-O, if the paging information cannot be detected or is decoded incorrectly, and/or the detected strength is lower than the configured threshold, the UE 104 can monitor the alert message sent by the BS 102, according to the detection time window T1 and the detection period t1, such as discussed herein. The UE 104 can start timing from the detection time window T1 initially and attempt to detect the alert message at (or every) interval period t1. When the timeout expires, if the UE 104 does not detect the alert message sent by the BS 102, such as dedicated sequence, DMRS, etc., the UE 104 may determine that it is in a weak coverage region.

### Example Implementation 2: Action or Behavior of UE in Poor Channel/Coverage

In various configurations, the UE 104 can be configured to perform certain actions, procedures, or operations responsive to or after determining that the UE 104 is in a weak coverage area/location/region. The actions can include, but are not limited to those discussed herein. For example, if the UE 104 is in a weak coverage (e.g., weak coverage area or poor channel), the lower layer of the UE 104 can send an indication or an indicator (e.g., sometimes referred to as the first indication) to higher layer to indicate that the channel is poor (e.g., an indicator that a signal is poor, etc.). In this case, the higher layer received the indication from the lower layer of the UE 104 can notify the user by activating a flag or pop-up indication (or other types of indication/indicator) based on or according to the content of the indication, for example, the pop-up indicator or the flag can include at least one of: an indicator of whether to move, an indicator indicating cellular coverage performance, an indicator of whether there is cellular coverage, and/or information including the recommended position, etc. Additionally or alternatively, at least one of the following configurations can be considered as part of the action (e.g., the recommended position):
1) The BS 102 can provide at least one available geographic area information, including at least one of the location coordinates, a radius list of the center of the valid or available geographical area, or other indications of at least one valid area. For instance, the beam or cell edge coverage may be poor.
   a. The indication can include or correspond to one or more concentric circular areas (e.g., circles or ovals), with corresponding levels of channel or coverage performance that vary monotonically across the various concentric circular areas (e.g., gradually decreasing performance from the inside out). The radius can be described, for example, as follows:
      i. Multiple radii can be used to determine the concentric circular areas based on the same center and multiple radii;
      ii. The radius can be a first radius and one or more offset values relative to the first radius, where each of the offset values can correspond to a respective one of the concentric circular areas (e.g., at least one or more offsets value can be used to determine the one or more outer concentric circular areas relative to the innermost side);
      iii. At least one coordinate, each corresponding to a reference point or center point of one or more of the concentric circular areas; and/or
      iv. The radius can be made into a table and/or indexed, and broadcasted with at least one or more index values.
   b. The indication can include or correspond to at least one of one or multiple non-concentric circular areas with relatively good performance within a beam or a cell. In some cases, the indication can include various coordinates, each corresponding to a reference point or center point of a respective one of the one or more non-concentric circular areas. The following examples can provide the relationship between the radius and the center of the circle:
      i. The radius and center can be one-on-one, with one radius corresponding to one center (or coordinate) (e.g., one radius can correspond to one non-concentric circular area or one coordinate); and/or
      ii. The radius and center can be one-to-multiple, with one radius corresponding to multiple centers (e.g., at least one radius, each corresponding to multiple non-concentric circular areas, or multiple coordinates).
2) The BS 102 may provide available geographic area information (e.g., indication), including at least one of a list of location coordinates to define or indicate a boundary or coverage of a respective one of the at least one valid or available geographical area. The corresponding closed shapes can be explained by polygons connecting these points in the list, for example. The BS 102 can provide this type of indication, for example, for mountainous areas, depressions, and/or other areas with complex terrain, among other types of areas.

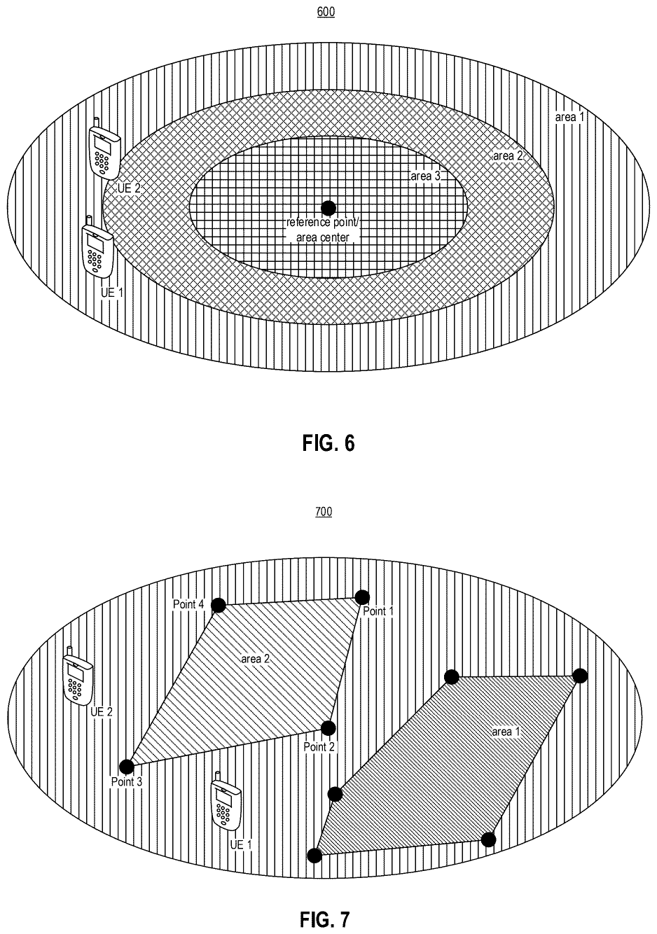

FIG. 6 illustrates an example circular geographical area 600 of non-terrestrial network (NTN) areas, in accordance with some embodiments of the present disclosure. For example, for each available NTN area, the corresponding geographical area information can be provided by the BS 102 (or the network), e.g., approximate cell center and/or list of cell radii. As shown, FIG. 6 provides three NTN areas within an NTN cell, although more or less areas can be provided by the BS 102 via or included in the indication. Different NTN areas may have different coverage performance and the UE 104 can have different behavior (or response) based on or according to its location and/or the corresponding geographical area information. For example, the UE 104 in area 3 may have good coverage and maintains its current state; the UE 104 located in area 2 can maintain its current state or move to area 1 to get better coverage; and/or the UE 104 in area 1 may be notified/informed to move to area 2 or 3 because of the poor coverage.

FIG. 7 illustrates an example polygon geographical area 700 of NTN areas, in accordance with some embodiments of the present disclosure. For example, for each NTN area, the BS 102 can provide or indicate a list of locations, and the corresponding closed shape can be illustrated by a polygon connecting these points within the list, such as shown in FIG. 7. In some cases, an explicit indication may be provided for the available NTN area in each NTN cell, which can be considered as the target available areas for the UEs 104 in NTN area for moving. This indication may be applied or applicable, for example, when an NTN cell covers various complex terrains, such as oceans, hills, mountains, plateaus, etc.

### Example Implementation 3: Configuration of DCI-based Overridden or Direction Indication

In certain specifications, such as for narrowband (NB)-internet of things (IoT), among others, the ACK or NACK resource field in DCI format N1 can include 16 states (or other numbers of states) indicating the subcarrier index and/or the time offset from the end of PDSCH (NPDSCH) to the beginning of PUSCH (NPUSCH) carrying ACK or NACK response, such as provided in examples Table 1 and/or Table 2. For example, the example Table 1 can be for the configuration of 15 kHz subcarrier spacing, and the example Table 2 can be for the configuration of 3.75 kHz subcarrier spacing. For enhanced machine type communication control element (eMTC CE) mode B, for instance, the “HARQ-ACK resource offset” field in DCI format 6-1B can include four states indicating the resource offset of NPUSCH carrying ACK or NACK response.

To mitigate the impact of HARQ stalling with potential improvement on the data rate for IoT NTN cases to allow/enable more services, among other potential improvements or benefits, the implementations or operations to configure the HARQ feedback enabling or disabling can be provided in the specification. In various implementations, the present disclosure can provide operations or methods to configure DCI-based overridden or direct indication.

EXAMPLE TABLE 1
ACK or NACK subcarrier and k₀ for NPUSCH with
subcarrier spacing Δf = 15 kHz.

| ACK/NACK | ACK/NACK | |
|---|---|---|
| resource field | subcarrier | k₀ |
| 0 | 0 | 13 |
| 1 | 1 | 13 |
| 2 | 2 | 13 |
| 3 | 3 | 13 |
| 4 | 0 | 15 |
| 5 | 1 | 15 |
| 6 | 2 | 15 |
| 7 | 3 | 15 |
| 8 | 0 | 17 |
| 9 | 1 | 17 |
| 10 | 2 | 17 |
| 11 | 3 | 17 |
| 12 | 0 | 18 |
| 13 | 1 | 18 |
| 14 | 2 | 18 |
| 15 | 3 | 18 |

EXAMPLE TABLE 2
ACK or NACK subcarrier and k₀ for NPUSCH with
subcarrier spacing Δf = 3.75 kHz.

| ACK/NACK | ACK/NACK | |
|---|---|---|
| resource field | subcarrier | k₀ |
| 0 | 38 | 13 |
| 1 | 39 | 13 |
| 2 | 40 | 13 |
| 3 | 41 | 13 |
| 4 | 42 | 13 |
| 5 | 43 | 13 |
| 6 | 44 | 13 |
| 7 | 45 | 13 |
| 8 | 38 | 21 |
| 9 | 39 | 21 |
| 10 | 40 | 21 |
| 11 | 41 | 21 |
| 12 | 42 | 21 |
| 13 | 43 | 21 |
| 14 | 44 | 21 |
| 15 | 45 | 21 |

EXAMPLE TABLE 3
Mapping of ACK or NACK Resource offset Field in DCI format
1A/1B/1D/1/2A/2/2B/2C/2D/6-1A/6-1B to Δ_{ARO} values.

| ACK or NACK Resource offset field in DCI | |
|---|---|
| format 1A/1B/1D/1/2A/2/2B/2C/2D/6-1A/6-1B | Δ_{ARO} |
| 0 | 0 |
| 1 | −1 |
| 2 | −2 |
| 3 | 2 |

For DCI-based overridden or direct indication, HARQ-ACK resource field in DCI format N1 and HARQ-ACK resource offset field in DCI format 6-1B can be used or interpreted to indicate DCI-based overridden or direct indication.

In certain systems, such as for NB-IoT, any state (e.g., ACK or NACK resource field shown in the example Tables 1 or 2) in “HARQ-ACK resource” field in DCI format N1 can be used for indication of maintaining or reversing the HARQ feedback enabled (or allowed) or disabled for the corresponding transmission from per-HARQ process RRC configuration, and/or corresponding HARQ-ACK resource in case the indication of HARQ feedback is allowed/enabled. For eMTC CE mode B, any state (e.g., ACK or NACK resource offset field, such as shown in example Table 3) in “HARQ-ACK resource offset” field in DCI format 6-1B can be used for indication of maintaining or reversing the HARQ feedback enabled or disabled for the corresponding transmission from per-HARQ process RRC configuration, and/or corresponding HARQ-ACK resource in case the indication of HARQ feedback is allowed/enabled. In some cases, the state used to indicate overridden or direct indication can be the same for different UEs 104 to avoid frequent configuration, for instance, to minimize or reduce the signaling overhead (e.g., avoid the increase of signaling overhead). The following examples can be provided for indicating DCI-based overridden or direct indication.

Example 1: For NB-IoT, state 0 in the ACK or NACK resource field in the DCI format N1 can be used to indicate overridden or direct indication for the configuration of 15 kHz subcarrier spacing. When the “HARQ-ACK resource” field in DCI format N1 indicates state 0, if the initial HARQ-ACK feedback is disabled (e.g, configured by per-HARQ process RRC signaling), then the HARQ feedback can be maintained disabled (e.g., kept disabled); if the initial HARQ feedback is allowed/enabled (e.g, configured by per-HARQ process RRC signaling), the HARQ feedback can be reversed to disabled. When the “HARQ-ACK resource” in DCI format N1 indicates any state other than state 0 (e.g., state 1, state 2, . . . , or state 15, such as in the example Table 1), if the initial HARQ feedback is disabled (e.g, configured by per-HARQ process RRC signaling), then the HARQ feedback can be reversed to allowed/enabled, and if the initial HARQ feedback is allowed/enabled (e.g, configured by per-HARQ process RRC signaling), the HARQ feedback can be maintained enabled.

Example 2: For NB-IoT, state 3 in the ACK or NACK resource field in the DCI format N1 can be used to indicate overridden or direct indication for the configuration of 15 kHz subcarrier spacing. When the “HARQ-ACK resource” in DCI format N1 indicates state 3, if the initial HARQ-ACK feedback is disabled (e.g, configured by per-HARQ process RRC signaling), the HARQ feedback can be maintained disabled; if the initial HARQ feedback is allowed/enabled (e.g, configured by per-HARQ process RRC signaling), the HARQ feedback can be reversed to disabled. When the “HARQ-ACK resource” in DCI format N1 indicates any state other than state 3 (e.g., state 1, state 2, state 4, . . . , or state 15, such as in the example Table 1), if the initial HARQ feedback is disabled (e.g, configured by per-HARQ process RRC signaling), the HARQ feedback can be reversed to allowed/enabled; if the initial HARQ feedback is allowed/enabled (e.g, configured by per-HARQ process RRC signaling), the HARQ feedback (e.g., state of the (initial) HARQ feedback) can be maintained enabled.

Example 3: For NB-IoT, state 4 in the ACK or NACK resource field in the DCI format N1 can be used to indicate overridden or direct indication for the configuration of 15 kHz subcarrier spacing. When the “HARQ-ACK resource” in DCI format N1 indicates state 4, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 4 (e.g., state 1, state 2, state 3, state 5, . . . , or state 15, such as in the example Table 1), if the initial HARQ feedback is disabled, the HARQ feedback can be reversed to allowed/enabled; if the initial HARQ feedback is allowed/enabled, the HARQ feedback can be maintained enabled.

Example 4: For NB-IoT, state 7 in the ACK or NACK resource field in the DCI format N1 can be used to indicate overridden or direct indication for the configuration of 15 kHz subcarrier spacing. When the “HARQ-ACK resource” in DCI format N1 indicates state 7, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 7 (e.g., state 1, state 2, . . . , state 6, state 8, . . . , or state 15, such as in the example Table 1), if the initial HARQ feedback is disabled, the HARQ feedback can be reversed to allowed/enabled; if the initial HARQ feedback is allowed/enabled, the HARQ feedback can be maintained.

Example 5: For NB-IoT, state 8 in the ACK or NACK resource field in the DCI format N1 can be used to indicate overridden or direct indication for the configuration of 15 kHz subcarrier spacing. When the “HARQ-ACK resource” in DCI format N1 indicates state 8, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 8 (e.g., state 1, state 2, . . . , state 7, state 9, . . . , or state 15, such as in the example Table 1), if the initial HARQ feedback is disabled, the HARQ feedback can be reversed to allowed/enabled; if the initial HARQ feedback is allowed/enabled, the HARQ feedback can be maintained enabled.

Example 6: For NB-IoT, state 11 in the ACK or NACK resource field in the DCI format N1 can be used to indicate overridden or direct indication for the configuration of 15 kHz subcarrier spacing. For example, when the “HARQ-ACK resource” in DCI format N1 indicates state 11, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 11 (e.g., state 0, state 1, . . . , state 10, state 12, . . . , or state 15, such as in the example Table 1), if the initial HARQ feedback is disabled, the HARQ feedback can be reversed to allowed/enabled; if the initial HARQ feedback is allowed/enabled, the HARQ feedback can be maintained enabled.

Example 7: For NB-IoT, state 12 in the ACK or NACK resource field in the DCI format N1 can be used to indicate overridden or direct indication for the configuration of 15 kHz subcarrier spacing. For example, when the “HARQ-ACK resource” in DCI format N1 indicates state 12, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 12 (e.g., state 0, state 1, . . . , state 11, state 13, state 14, or state 15, such as in the example Table 1), if the initial HARQ feedback is disabled, the HARQ feedback can be reversed to allowed/enabled; if the initial HARQ feedback is allowed/enabled, the HARQ feedback can be maintained enabled.

Example 8: For NB-IoT, state 15 in the ACK or NACK resource field in the DCI format N1 can be used to indicate overridden or direct indication for the configuration of 15 kHz subcarrier spacing. When the “HARQ-ACK resource” in DCI format N1 indicates state 15, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 15 (e.g., state 0, state 1, . . . , or state 14, such as in the example Table 1), if the initial HARQ feedback is disabled, the HARQ feedback can be reversed to allowed/enabled; if the initial HARQ feedback is allowed/enabled, the HARQ feedback can be maintained enabled.

Example 9: For NB-IoT, state 0 in the ACK or NACK resource field in the DCI format N1 can be used to indicate overridden or direct indication for the configuration of 3.75 kHz subcarrier spacing. When the “HARQ-ACK resource” in DCI format N1 indicates state 0, if the initial HARQ-ACK feedback is disabled (e.g, configured by per-HARQ process RRC signaling), the HARQ feedback can be maintained disabled; if the initial HARQ feedback is allowed/enabled (e.g, configured by per-HARQ process RRC signaling), the HARQ feedback can be reversed to disabled. When the “HARQ-ACK resource” in DCI format N1 indicates any state other than state 0 (e.g., state 1, state 2, . . . , or state 15, such as in the example Table 2), if the initial HARQ feedback is disabled (e.g, configured by per-HARQ process RRC signaling), the HARQ feedback can be reversed to allowed/enabled; if the initial HARQ feedback is allowed/enabled (e.g, configured by per-HARQ process RRC signaling), the HARQ feedback can be maintained enabled.

Example 10: For NB-IoT, state 7 in the ACK or NACK resource field in the DCI format N1 can be used to indicate overridden or direct indication for the configuration of 3.75 kHz subcarrier spacing. When the “HARQ-ACK resource” in DCI format N1 indicates state 7, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 7 (e.g., state 1, state 2, . . . , state 6, state 8, . . . , or state 15, such as in the example Table 2), if the initial HARQ feedback is disabled, the HARQ feedback can be reversed to allowed/enabled; if the initial HARQ feedback is allowed/enabled, the HARQ feedback can be maintained enabled.

Example 11: For NB-IoT, state 8 in the ACK or NACK resource field in the DCI format N1 can be used to indicate overridden or direct indication for the configuration of 3.75 kHz subcarrier spacing. When the “HARQ-ACK resource” in DCI format N1 indicates state 8, if the initial HARQ-ACK feedback is disabled (e.g, configured by per-HARQ process RRC signaling), the HARQ feedback can be maintained disabled; if the initial HARQ feedback is allowed/enabled (e.g, configured by per-HARQ process RRC signaling), the HARQ feedback can be reversed to disabled. When the “HARQ-ACK resource” in DCI format N1 indicates any state other than state 8 (e.g., state 1, state 2, . . . , state 7, state 9, . . . , or state 15, such as in the example Table 2), if the initial HARQ feedback is disabled (e.g, configured by per-HARQ process RRC signaling), the HARQ feedback can be reversed to allowed/enabled; if the initial HARQ feedback is allowed/enabled (e.g, configured by per-HARQ process RRC signaling), the HARQ feedback can be maintained enabled.

Example 12: For NB-IoT, state 15 in the ACK or NACK resource field in the DCI format N1 can be used to indicate overridden or direct indication for the configuration of 3.75 kHz subcarrier spacing. When the “HARQ-ACK resource” in DCI format N1 indicates state 15, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format N1 indicates any state other than state 15 (e.g., state 1, state 2, . . . , or state 14, such as in the example Table 2), if the initial HARQ feedback is disabled, the HARQ feedback can be reversed to allowed/enabled; if the initial HARQ feedback is allowed/enabled, the HARQ feedback can be maintained enabled.

Example 13: For eMTC, state 0 in the ACK or NACK resource offset field in the DCI format 6-1B can be used to indicate overridden or direct indication. When the “HARQ-ACK resource offset” in DCI format 6-1B indicates state 0, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format 6-1B indicates any state other than state 0 (e.g., state 1, state 2, or state 3, such as in the example Table 3), if the initial HARQ feedback is disabled, the HARQ feedback can be reversed to allowed/enabled; if the initial HARQ feedback is allowed/enabled, the HARQ feedback can be maintained enabled.

Example 14: For eMTC, state 1 in the ACK or NACK resource offset field in the DCI format 6-1B can be used to indicate overridden or direct indication. When the “HARQ-ACK resource offset” in DCI format 6-1B indicates state 1, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format 6-1B indicates any state other than state 1 (e.g., state 0, state 2, or state 3, such as in the example Table 3), if the initial HARQ feedback is disabled, the HARQ feedback can be reversed to allowed/enabled; if the initial HARQ feedback is allowed/enabled, the HARQ feedback can be maintained enabled.

Example 15: For eMTC, state 2 in the ACK or NACK resource offset field in the DCI format 6-1B can be used to indicate overridden or direct indication. When the “HARQ-ACK resource offset” in DCI format 6-1B indicates state 2, if the initial HARQ-ACK feedback is disabled, the HARQ feedback can be maintained disabled; if the initial HARQ feedback is allowed/enabled, the HARQ feedback can be reversed to disabled. When the “HARQ-ACK resource” in DCI format 6-1B indicates any state other than state 2 (e.g., state 0, state 1, or state 3, such as in the example Table 3), if the initial HARQ feedback is disabled, the HARQ feedback can be reversed to allowed/enabled; if the initial HARQ feedback is allowed/enabled, the HARQ feedback can be maintained enabled.

Example 16: For eMTC, state 3 in the ACK or NACK resource offset field in the DCI format 6-1B can be used to indicate overridden or direct indication. When the “HARQ-ACK resource offset” in DCI format 6-1B indicates state 3, if the initial HARQ-ACK feedback is disabled, the HARQ feedback can be maintained disabled; if the initial HARQ feedback is allowed/enabled, the HARQ feedback can be reversed to disabled. When the “HARQ-ACK resource offset” in DCI format 6-1B indicates any state other than state 3 (e.g., state 0, state 1, or state 2, such as in the example Table 3), if the initial HARQ feedback is disabled, the HARQ feedback can be reversed to allowed/enabled; if the initial HARQ feedback is allowed/enabled, the HARQ feedback can be maintained enabled.

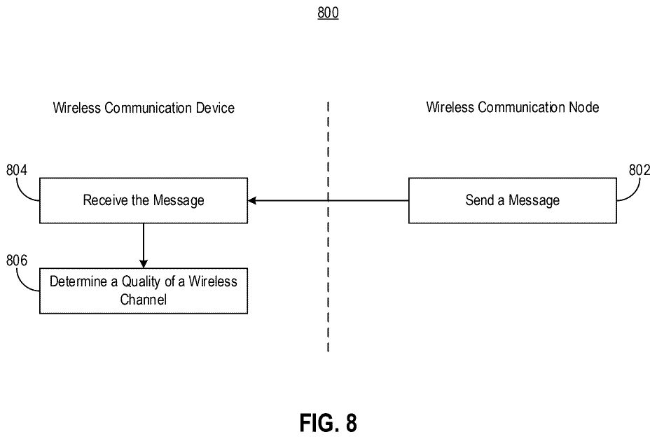

FIG. 8 illustrates a flow diagram of an example method 800 for coverage enhancement in NTN. The method 800 may be implemented using any one or more of the components and devices detailed herein in conjunction with FIGS. 1-7. In brief overview, the method 800 may be performed by at least one wireless communication device (e.g., a UE or terminal device), at least one wireless communication node (e.g., a BS, gNB, or access network equipment), at least one satellite, etc., in some embodiments. Additional, fewer, or different operations may be performed in the method 800 depending on the embodiment. At least one aspect of the operations is directed to a system, method, apparatus, or a computer-readable medium.

At operation 802, a wireless communication node can send/transmit/provide/communicate/forward/signal a message to/for detection (e.g., alert message or detection message) to the wireless communication device. At operation 804, the wireless communication device can receive/obtain/acquire the message to detection from the wireless communication node.

In some implementations, the message can include a defined signal (e.g., existing or new, such as based on a certain sequence) or channel transmission. The message can include at least one of: a paging message; a wake-up signal (WUS) or group WUS (GWUS) for paging; a paging early indication (PEI) for paging; a downlink control information signaling or a transmission of a physical downlink control channel (PDCCH); a demodulation reference signal (DMRS); a channel state information reference signal (CSI-RS) based reference signal (RS); a tracking reference signal (TRS); a secondary synchronization signal (SSS) based signal; a RS in combination with a synchronization signal block (SSB); a RS with a specific sequence (e.g., an existing RS with a new sequence); and/or a message based on a defined sequence.

In some implementations, the defined sequence can include or is based on or according to at least one of: a pseudo-random sequence, a Gold sequence, a low peak-to-average power ratio (PAPR) sequence, defined by a cyclic shift of a base sequence, a Zadoff-Chu (ZC) sequence, an m sequence, a Hadamard sequence, a cyclic shift of a ZC sequence, an orthogonal sequence, a UE group specific sequence, a UE specific sequence, a sequence assigned or determined based on a UE specific basis, a RS sequence with defined pattern, a defined RS sequence, at least one of a sequence or pattern of a defined reference signal (e.g., new RS sequence and/or pattern), and/or a sequence based at least on WUS design.

In some implementations, the message (e.g., the alert message) can be specific to: the wireless communication device (e.g., UE specific), a group of wireless communication devices (e.g., UE group specific), and/or a cell (e.g., cell specific), among others. In some implementations, the message may be transmitted by the wireless communication node, following a paging message transmitted at one or more paging occasions of the wireless communication device, for the wireless communication device that has entered RRC_CONNECTED, RRC_INACTIVE, and/or RRC_IDLE state.

In some implementations, the message may be transmitted by the wireless communication node, following a paging message with paging information initiated by core network (CN) or radio access network (RAN), transmitted at one or more paging occasion of the wireless communication device, for the wireless communication device that has entered RRC_INACTIVE, and/or RRC_IDLE state. In some implementations, the message can be transmitted by the wireless communication node, following a wake-up signal (WUS) or group WUS (GWUS) transmitted in a WUS transmission opportunity for incoming paging information, for the wireless communication device that has entered RRC_IDLE state; the RRC_IDLE state of the wireless communication device may be in response to or triggered by at least one of: reception of an RRCEarlyDataComplete indication, reception of an RRCConnectionRelease indication not including an noLastCellUpdate indication, and/or reception of the RRCConnectionRelease indication including the noLastCellUpdate indication, where a start of the WUS transmission opportunity may be determined by a time offset according to a gap between an end of a prior WUS or GWUS and an associated paging occasion.

In some implementations, the message may be transmitted by the wireless communication node, following a paging early indication (PEI) transmitted at a PEI occasion for incoming paging information, for the wireless communication device that has entered RRC_IDLE or RRC_INACTIVE state; the PEI occasion can include a set of PDCCH monitoring occasions (MOs); the PEI occasion include one or more time slots specified by an nrofPDCCH-MonitoringOccasionPerSSB-InPO indication; a time location of the PEI occasion may be determined by a reference point and an offset; the reference point may be at a start of a reference frame determined by a frame-level offset; and/or the offset can be a symbol-level offset from the reference point to a start of a first physical downlink control channel (PDCCH) MO of the PEI occasion.

In some implementations, at least one of: the message may be transmitted by the wireless communication node at a resource configured via higher layer signaling by the wireless communication node; and/or the resource can include at least one of: a time domain resource to send the message, a frequency domain resource to send the message, and/or a radio network temporary identifier (RNTI) that is specific to a group of wireless communication devices, specific to the wireless communication device, and/or specific to a cell of the wireless communication device, to scramble or initialize the message. In this case, the higher layer signaling can include at least one of: radio resource control (RRC) signaling, medium access control (MAC) signaling, and/or system information block (SIB) signaling, among other types of signalings.

At operation 806, the wireless communication device can determine a quality of the wireless channel (e.g., coverage area or channel quality). For instance, the wireless communication device can determine whether the quality of the wireless channel is poor, such as the wireless communication device is in a relatively poor coverage area/region/location.

In some implementations, the wireless communication device can determine that the quality of the wireless channel is poor, when at least one of the following conditions is satisfied/met: the detecting or decoding of the message has failed; number of attempts at detecting or decoding the message has reached a first configured maximum number of times and have failed; a detected strength of the message is lower than a first configured threshold; a detection window of the message that includes a plurality of detection periods has expired; detection or decoding of an associated paging channel has failed; number of attempts at detecting the associated paging channel has reached a second configured maximum number of times and have failed; a detected strength of paging is lower than a second configured threshold; detection or decoding of a wake-up signal (WUS) or group WUS (GWUS) has failed; number of attempts at detecting or decoding the WUS or GWUS has reached a third configured maximum number of times and have failed; a detected strength of the WUS or GWUS is lower than a third configured threshold; detection or decoding of a paging early indication (PEI) signal has failed; number of attempts at detecting or decoding the PEI has reached a fourth configured maximum number of times and have failed; a detected strength of the PEI signal is lower than a fourth configured threshold; and/or all candidate cells are not detected. In this case, at least one of the first, second, third, or fourth configured maximum number of times, the first, second, third, or fourth configured threshold, and/or the detection window is configured by a higher layer signaling. The higher layer signaling can include at least one of, but is not limited to: a radio resource control (RRC) signaling, a medium access control (MAC) signaling, and/or a system information block (SIB) signaling.

In some implementations, the wireless communication device can send a first indication to a higher layer to indicate that a channel condition is poor. The higher layer can include at least one of: a medium access control (MAC) layer, a radio resource control (RRC) layer, an application layer, and/or a layer higher than a physical layer, etc. The first indication can include at least one of: a measured signal strength, an indicator of signal strength, an indicator that a signal is poor, and/or information including a recommended position, among others.

In some implementations, the information including the recommended position can include: an indication of at least one valid or available geographical area. In some implementations, the indication can include an indication of at least one of: a plurality of concentric circular areas, with corresponding levels of channel or coverage performance that vary monotonically across the plurality of concentric circular areas; a plurality of radii of the plurality of concentric circular areas; at least one coordinate, each corresponding to a reference point or center point of one or more of the plurality of concentric circular areas; and/or a first radius and at least one offset value relative to the first radius, each of the at least one offset value corresponding to a respective one of the plurality of concentric circular areas. The indication may be one or more absolute values (e.g., of radius or offset), or indices/indexes representing the absolute values, which can be indicated/provided in a list or a table format, or other types of data structures.

In some implementations, the indication can include an indication of at least one of: one or more non-concentric circular areas; a plurality of coordinates, each corresponding to a reference point or center point of a respective one of the one or more non-concentric circular areas; and/or at least one radius each corresponding to at least one of the one or more non-concentric circular areas, or each corresponding to at least one of the plurality of coordinates. For example, the radius and center can be one-on-one, with one radius corresponding to one center. In another example, the radius and center can be one-to-many, with one radius corresponding to multiple centers. The indication may be one or more absolute values (e.g., of radius or offset), or indices/indexes representing the absolute values, which can be indicated/provided in a list or a table format, or other types of data structures.

In some implementations, the indication can include an indication of at least one of: a plurality of coordinates to define a boundary or coverage of a respective one of the at least one valid or available geographical area. The indication may be one or more absolute values (e.g., of radius or offset), or indices/indexes representing the absolute values, which can be indicated/provided in a list or a table format, or other types of data structures.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, information via a signaling; and
determining, by the wireless communication device, a hybrid automatic repeat request (HARQ) feedback state according to the information.

2. The method of claim 1, wherein the information comprises at least one of:
a per-HARQ process RRC configuration;
an overridden or direct indication for configuration;
information in a hybrid automatic repeat request acknowledgement (HARQ-ACK) resource field; or
information in a HARQ-ACK resource offset field.

3. The method of claim 1, wherein the signaling comprises at least one of:
a radio resource control (RRC) signaling; or
a downlink control information (DCI) signaling;
wherein the DCI signaling comprises at least one of: DCI format N1, or DCI format 6-1B.

4. The method of claim 1, wherein the HARQ feedback state comprises:
a HARQ feedback enabled state; or
a HARQ feedback disabled state.

5. The method of claim 1, wherein the HARQ feedback state is determined according to:
the information, from a HARQ-ACK resource field in downlink control information (DCI) format N1 of the signaling, wherein the information functions as a DCI-based overridden or direct indication.

6. The method of claim 5, wherein the information indicates a state of 15.

7. The method of claim 1, wherein the HARQ feedback state is determined according to:
the information, from a HARQ-ACK resource offset field in downlink control information (DCI) format 6-1B of the signaling, wherein the information functions as a DCI-based overridden or direct indication.

8. The method of claim 1, wherein the information indicates a state of 3.

9. The method of claim 5, wherein the DCI-based overridden or direct indication comprises at least one of:
an indication to reverse a HARQ feedback disabled state from per-HARQ process RRC configuration, to HARQ feedback enabled state for a corresponding transmission;
an indication to reverse a HARQ feedback enabled state from per-HARQ process RRC configuration, to HARQ feedback disabled state for a corresponding transmission;
an indication to reverse a HARQ feedback enabled state to HARQ feedback disabled state for a corresponding transmission;
an indication to indicate a HARQ feedback disabled state for a corresponding transmission; or
an indication to indicate a HARQ feedback enabled state for a corresponding transmission.

10. The method of claim 1, wherein the HARQ feedback state is determined according to the information, which is from a per-HARQ process RRC signaling.

11. The method of claim 1, wherein the determining comprises at least one of:
determining, by the wireless communication device, information of a HARQ acknowledgement (HARQ-ACK) resource field in downlink control information (DCI) format N1 of the signaling as a DCI-based overridden or direct indication, to reverse a HARQ feedback disabled state from per-HARQ process RRC configuration, to HARQ feedback enabled state for a corresponding transmission;
determining, by the wireless communication device, the information of the HARQ-ACK resource field in DCI format N1 of the signaling as a DCI-based overridden or direct indication, to reverse a HARQ feedback enabled state from per-HARQ process RRC configuration, to HARQ feedback disabled state for a corresponding transmission;
determining, by the wireless communication device, the information of the HARQ-ACK resource field in DCI format N1 of the signaling as a DCI-based overridden or direct indication, to reverse a HARQ feedback enabled state to HARQ feedback disabled state for a corresponding transmission;
determining, by the wireless communication device, the information from a per-HARQ process RRC configuration, to indicate a HARQ feedback disabled state for a corresponding transmission;
determining, by the wireless communication device, the information from a per-HARQ process RRC configuration, to indicate a HARQ feedback enabled state for a corresponding transmission;
determining, by the wireless communication device, the information of the HARQ-ACK resource field in DCI format N1 of the signaling as a DCI-based overridden or direct indication, to indicate a HARQ feedback disabled state for a corresponding transmission; or
determining, by the wireless communication device, the information of the HARQ-ACK resource field in DCI format N1 of the signaling as a DCI-based overridden or direct indication, to indicate a HARQ feedback enabled state for a corresponding transmission.

12. The method of claim 1, wherein the determining comprises at least one of:
determining, by the wireless communication device, information of a HARQ acknowledgement (HARQ-ACK) resource offset field in downlink control information (DCI) format 6-1B of the signaling, as a DCI-based overridden or direct indication to reverse a HARQ feedback disabled state from per-HARQ process RRC configuration to enabled for a corresponding transmission;
determining, by the wireless communication device, the information of the HARQ-ACK resource offset field in DCI format 6-1B of the signaling as a DCI-based overridden or direct indication, to reverse a HARQ feedback enabled state from per-HARQ process RRC configuration to HARQ feedback disabled state for a corresponding transmission;
determining, by the wireless communication device, the information of the HARQ-ACK resource offset field in DCI format 6-1B of the signaling as a DCI-based overridden or direct indication, to reverse a HARQ feedback enabled state to HARQ feedback disabled state for a corresponding transmission;
determining, by the wireless communication device, the information of the HARQ-ACK resource offset field in DCI format 6-1B of the signaling as a DCI-based overridden or direct indication, to indicate a HARQ feedback disabled state for a corresponding transmission; or
determining, by the wireless communication device, the information of the HARQ-ACK resource offset field in DCI format 6-1B of the signaling as a DCI-based overridden or direct indication, to indicate a HARQ feedback enabled state for a corresponding transmission.

13. A method comprising:
transmitting, by a wireless communication node to a wireless communication device, information via a signaling; and
causing the wireless communication device to determine a hybrid automatic repeat request (HARQ) feedback state according to the information.

14. The method of claim 13, wherein the information comprises at least one of:
a per-HARQ process RRC configuration;
an overridden or direct indication for configuration;
information in a hybrid automatic repeat request acknowledgement (HARQ-ACK) resource field; or
information in a HARQ-ACK resource offset field.

15. A wireless communication node, comprising:
at least one processor configured to:
transmit, via a transmitter to a wireless communication device, information via a signaling; and
cause, via the transmitted information, the wireless communication device to determine a hybrid automatic repeat request (HARQ) feedback state.

16. A wireless communication device, comprising:
at least one processor configured to:
receive, via a receiver from a wireless communication node, information via a signaling; and
determine a hybrid automatic repeat request (HARQ) feedback state according to the information.

17. The method of claim 16, wherein the information comprises at least one of:
a per-HARQ process RRC configuration;
an overridden or direct indication for configuration;
information in a hybrid automatic repeat request acknowledgement (HARQ-ACK) resource field; or
information in a HARQ-ACK resource offset field.

18. The method of claim 16, wherein the signaling comprises at least one of:
a radio resource control (RRC) signaling; or
a downlink control information (DCI) signaling,
wherein the DCI signaling comprises at least one of: DCI format N1, or DCI format 6-1B.

19. The method of claim 16, wherein the HARQ feedback state comprises:
a HARQ feedback enabled state; or
a HARQ feedback disabled state.

20. The method of claim 16, wherein the HARQ feedback state is determined according to:
the information, from a HARQ-ACK resource field in downlink control information (DCI) format N1 of the signaling, or
the information, from a HARQ-ACK resource offset field in downlink control information (DCI) format 6-1B of the signaling,
wherein the information functions as a DCI-based overridden or direct indication.
